(19) United States
(12) Patent Application Publication
(10) Pub. No.: US 2005/0264151 A1
(43) Pub. Date: Dec. 1, 2005

(54) Spark plug

(75) Inventors: Kouichi Mori, Kanagawa (JP); Koichi Inoue, Yokohama (JP); Hiroshi Isaji, Yokohama (JP); Kimiyoshi Nishizawa, Yokohama (JP)

Correspondence Address: FOLEY AND LARDNER;SUITE 500, 3000 K STREET NW, WASHINGTON, DC, 20007, US

(73) Assignee: NISSAN MOTOR CO., LTD.

(21) Appl. No.: 11/104,419

(22) Filed: Apr. 13, 2005

(30) Foreign Application Priority Data
May 27, 2004 (JP) 2004-156958

(51) Int. Cl. H01T 13/20

(52) U.S. Cl. 313/141; 313/143

(57) ABSTRACT

In a spark plug for a spark ignited internal combustion engine, an approximately cylindrical plug body having a mounting screw portion is provided, a center electrode supported on an inside of the plug body via an insulator is provided and a side electrode connected to a tip portion of the plug body and bent toward the inside of the plug body is provided, an atmospheric discharge being carried out across a discharge gap between tip portions of the center and side electrodes, the center electrode being positioned eccentrically at an opposite side to the side electrode from a center line of the spark plug, and both of the tip portions of the center and side electrodes constituting the discharge gap being faced against each other with respect to the center line of the spark plug.

### BACKGROUND OF THE INVENTION

1. Field of the invention

The present invention relates to a spark plug mainly used for a spark ignited internal combustion engine. The present invention, more specifically, relates to an improvement in an atmospheric discharge type spark plug which carries out an atmospheric discharge between mutually opposing center electrode and side electrode tip portions.

2. Description of the related art

Spark plugs used in an internal combustion engine are roughly divided into two types: an atmospheric discharge type spark plug which carries out the atmospheric discharge between mutually opposing center electrode tip portion and side electrode tip portion; and a creeping discharge type spark plug which carries out a discharge along an insulator tip surface between an outer peripheral surface of the center electrode and its adjacent side electrode. FIG. 2 of a Japanese Patent Application First Publication No. 2001-234842 published on Aug. 31, 2001 shows each structure of the atmospheric discharge type spark plug and the creeping discharge type spark plug. The atmospheric discharge type spark plug, as disclosed in the above-identified Japanese Patent Application First Publication, includes a rod shaped center electrode which is arranged on a center of a substantially cylindrical plug body having a mainly screw portion meshed with a plug hole of a cylinder head. A periphery of the center electrode is enclosed with a cylindrical insulator. A tip portion of the side electrode extended from a tip portion of the plug body in an approximately letter L shape is positioned on an extended line of a center line of the center electrode. A discharge gap between the center electrode and the side electrode is constructed along an axial direction of the spark plug. In more details, the tip portions of the center electrode and the side electrode constituting the discharge gap are mutually opposed along the center line of the spark plug (the center line of the plug body having the screw portion) and the atmospheric discharge along the spark plug center line is carried out.

### SUMMARY OF THE INVENTION

When an ignition is carried out through a jump discharge within a combustion chamber, an initial flame is developed in a proximity to a center part of a discharge gap and is extended radially from the center part of the discharge gap. Approximately, the initial flame is of a spherical body with a center part of the discharge gap as a center and its diameter is gradually enlarged. In the previously proposed spark plug, the center of the spherical initial flame is placed on a center line of the center electrode which a spark plug center line. Hence, in a process in which its diameter of the spherical initial flame is gradually larger, a rate of the initial frame contacted with an insulator tip portion enclosing the center electrode becomes relatively large. In other words, since the spherical initial flame is uniformly contacted in a peripheral direction with the tip portion of the insulator present on the surrounding of the tip portion of the center electrode, a volume of the insulator becomes relatively large which affects a cooling action on the initial flame and the initial flame becomes easy to be quenched. Consequently, a flame formation is prevented.

It is, therefore, an object of the present invention to provide an improved spark plug at an atmospheric discharge type which is capable of solving the above-described problem and providing a stable flame formation.

According to one aspect of the present invention, there is provided a spark plug, comprising: an approximately cylindrical plug body having a mounting screw portion; a center electrode supported on an inside of the plug body via an insulator; and a side electrode connected to a tip portion of the plug body and bent toward the inside of the plug body, an atmospheric discharge being carried out across a discharge gap between tip portions of the center and side electrodes, the center electrode being positioned eccentrically at an opposite side to the side electrode from a center line of the spark plug, and both of the tip portions of the center and side electrodes constituting the discharge gap being faced against each other with respect to the center line of the spark plug.

This summary of the invention does not necessarily describe all necessary features so that the invention may also be a sub-combination of these described features.

### BRIEF DESCRIPTION OF THE DRAWINGS

FIG. 1 is a cross sectioned view representing only an essential part of a first preferred embodiment of a spark plug according to the present invention.

FIG. 2 is an explanatory view for explaining a state of the spark plug shown in FIG. 1 in which an initial flame is expanded.

FIG. 3 is a cross sectioned view representing only an essential part of a second preferred embodiment of a spark plug according to the present invention.

FIG. 4 is a cross sectioned view representing only an essential part of a third preferred embodiment of the spark plug according to the present invention.

### DETAILED DESCRIPTION OF THE PREFERRED EMBODIMENTS:

Reference will hereinafter be made to the drawings in order to facilitate a better understanding of the present invention.

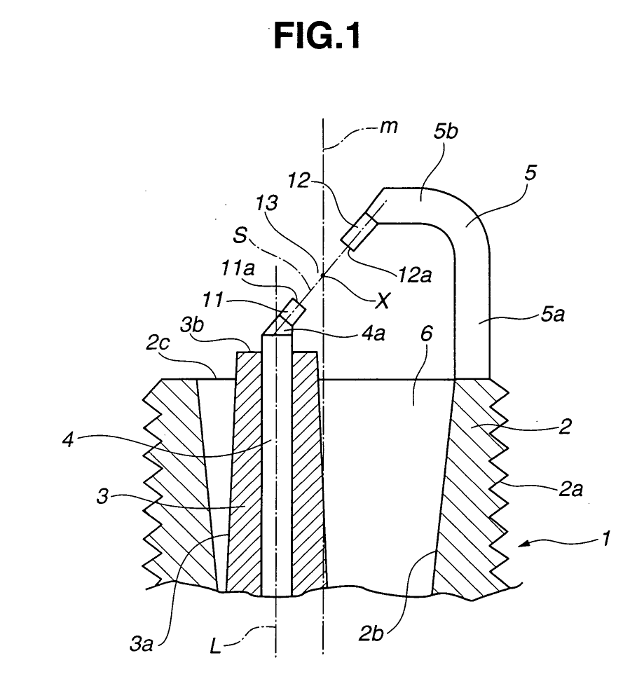

FIG. 1 shows a first preferred embodiment of a spark plug 1 for spark ignited internal combustion engine according to the present invention. It is noted that FIG. 1 shows only tip portions of electrodes which are essential parts of spark plug 1. This spark plug 1 includes: an approximately (substantially) cylindrical plug body 2 having a mounting screw portion 2a to mount this spark plug 1 on a plug hole of a cylinder head (not shown); a center electrode 4 having a cylindrical body and supported on an inside of plug body 2 via an insulator 3; and a side electrode 5 connected to a tip portion of plug body 2.

Plug body 2 includes a hexagon portion for detaching or attaching spark plug 1. A tip portion of plug body 2 exposed to the combustion chamber of the engine is formed in a cylindrical body having an inner wall portion 2b in a tapered surface in which an inner diameter is gradually expanded toward the tip portion of plug body 2. The above-described insulator 3 made of alumina is wholly approximately cylindrical shape, is inserted into an inner periphery of plug body 2, and is integrally fixed to plug body 2 by caulking an opening edge of plug body 2 placed in the vicinity to the hexagon portion (not shown). A tip portion of insulator 3 is of a slim cylinder shape having a tapered outer peripheral surface 3a on which the diameter thereof becomes gradually small toward the tip and is formed at a position eccentric toward one side from a spark plug center line m (a center line of plug body 2). Hence, a gap 6 which is developed between the tip portion of insulator 3 and inner wall surface 2b of plug body becomes larger at the one side in the peripheral direction. The tip end portion of insulator 3 has a tip end surface 3b which is projected over its whole periphery equally by a predetermined distance in the cylindrical shape.

Center electrode 4 is made of, for example, a nickel alloy and is fitted into insulator 3 and supported thereby with the tip portion of insulator 3 as a center. Hence, a center line L of center electrode 4 is placed at a position eccentric (offset) from the spark plug center line m and is in parallel to spark plug center line m. In addition, the tip portion of center electrode 4 is projected in the cylindrical shape from tip surface 3b of insulator 3 formed in an annular shape. In addition, a tapered portion 4a whose diameter becomes gradually smaller toward the tip end is formed. A center electrode side chip 11 in a cylindrical shape having a small diameter and made of a noble metal is attached onto a tip of a small diameter side of tapered portion 4a. This center electrode side chip 11 has a center axial line of its cylinder shape, as shown in FIG. 1, slanted through an acute angle with respect to center line L of center electrode 4. A tip surface 11a which provides substantially a discharge portion is formed of a plane orthogonal to the center axial line together with a base end surface which provides a junction surface toward center electrode 4. Hence, tapered portion 4a is of a slanted approximately truncated cone shape whose diameter is gradually varied from the outer diameter of a general portion of center electrode 4 to the outer diameter of center electrode side chip 11.

On the other hand, side electrode 5 is made of, for example, a nickel alloy and is joined onto a tip surface of plug body 2. Side electrode 5 is formed in an approximately letter-L shape having a base portion 5a extended from plug body 2 in parallel to spark plug center line m and an arm portion 5b bent at a substantially right angle from base portion 5a toward the inside of plug body 2. Arm portion 5b has its length short along a radial direction of spark plug 1 so that its tip thereof is not reached to spark plug center line m. It is noted that side electrode 5 has its base portion 5a of an approximately rectangular shape in cross section having a peripheral width wider than a thickness in the radial direction of spark plug 1. A side electrode side chip 12 is attached onto a tip inner side of side electrode 5 so as to project toward center electrode 4. Side electrode side chip 12 is of a cylindrical shape, is made of a noble metal, and has a small diameter. This side electrode side chip 12 has its cylindrical center axial line slanted through the acute angle with respect to center line m of spark plug 1 and its tip surface 12a which substantially provides the discharge portion forms a plane orthogonal to the center axial line together with the base end surface of side electrode side chip 12 which provides a junction surface toward center electrode 4.

Center electrode side chip 11 and side electrode side chip 12 are mutually opposed to (faced against) each other with respect to spark plug center line m. This center axial lines of these chips 11 and 12 are mutually coincident with each other. A discharge gap 13 is formed between tip surface 11a of center electrode side chip 11 and tip surface 12a of side electrode side chip 12. Center electrode 4 is eccentric (offset) from center line m of spark plug 1 in a direction opposite to side electrode 5. Center electrode side chip 11 is positioned on one side with center line m of spark plug 1 as the center and side electrode side chip 12 is positioned on the other side. Then, center electrode side and side electrode side chips 11 and 12 are aligned in the same straight line. Hence, a straight line S connecting between both chips 11, 12 is slanted with respect to center line m of spark plug 1 and is intersected with center line m of spark plug 1.

Especially, in the first embodiment, a center point X of discharge gap 13 between tip surfaces 11a, 12a is positioned on center line m of spark plug. In other words, each tip surface 11a, 12a is separated by mutually an equal distance from center line m of spark plug 1.

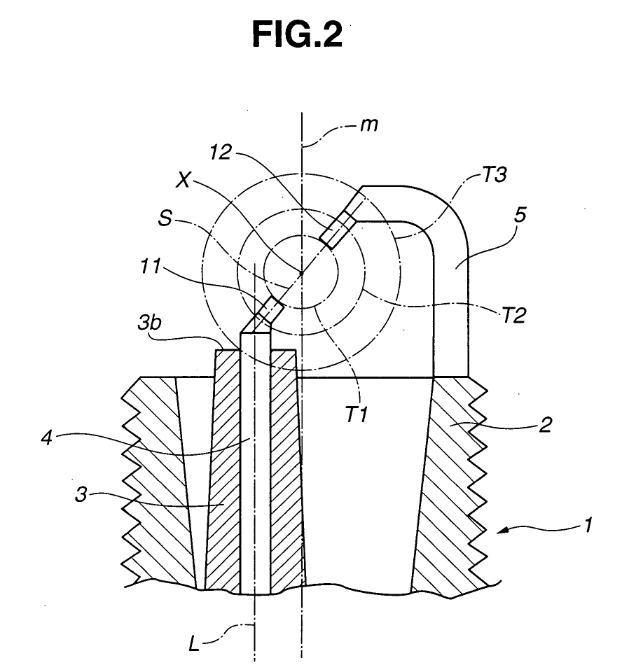

When, in spark plug 1 constructed as described above, a high voltage is supplied from an ignition coil (not shown), an aerial discharge (or atmospheric discharge) occurs in discharge gap 13, viz., in a space between center electrode side chip 11 and side electrode side chip 12 and the discharge spark ignites an air mixture fuel within the combustion chamber. At this time, an initial flame becomes spherical with center point X of discharge gap 13 as a center and its diameter of the spherical initial flame becomes large. FIG. 2 shows diagrammatically a situation of the development of this initial flame in spark plug 1 shown in FIG. 1. It will be appreciated that the spherical initial flame becomes gradually larger as the time has passed as shown by dot-line circles T1, T2, T3. At a certain time point, the initial flame is contacted with center electrode 4 and tip surface 3b of insulator 3 at the surrounding of center electrode 4. At this time, a quenching action due to a cooling is received. As shown in FIG. 2, in the case of spark plug 1 in this embodiment, the initial flame is developed with a position (viz., center point X) deviated from center line L of center electrode 4 (not on the position on center line L) as a center. Hence, since the contact of the initial flame with center electrode 4 and tip surface 3b of insulator 3 surrounding center electrode 4 becomes less, the quenching action becomes suppressed. On the other hand, the initial flame is developed with center point X on spark plug center line m as a center, for the whole spark plug 1. Hence, the ignition can be carried out at an appropriate position within the combustion chamber. In addition, an ignition position is not changed according to a mounting angle of plug body 2 when spark 1 is attached onto the cylinder head. Furthermore, in this embodiment, since the center axial line of center electrode side chip 11 is coincident with the center axial line of side electrode side chip 12, no partial wear occurs.

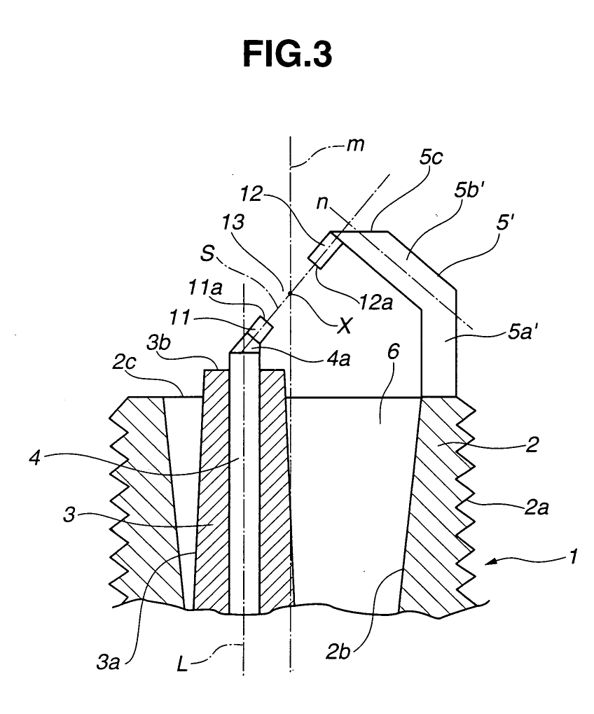

Next, FIG. 3 shows a second preferred embodiment of the spark plug according to the present invention. In the second embodiment, a difference point from the first embodiment is a modification of a shape of, especially, side electrode 5′. The other structure of spark plug 1 is generally the same as the first embodiment. Side electrode 5′ in this embodiment is formed in an approximately letter-L shape and includes a base portion 5a′ extended in parallel to spark plug center line m from plug body 2 and an arm portion 5b′ bent from base portion 5a′ toward the inside of plug body 2 through an obtuse angle. Especially, arm portion 5b′ is extended linearly and side electrode side chip 12 projected toward center electrode 4 is attached onto the inside of the tip of arm portion 5b′. Side electrode side chip 12 is formed in the small-diameter cylindrical shape as in the case of the first embodiment. Arm portion 5b′ has its axial line n orthogonal to straight line S connecting both electrode side chips 11 and 12. A tip outside portion 5c of arm portion 5b on the inside of which side electrode side chip 12 is attached is cut out along a plane orthogonal to center line m of spark plug 1. It is noted that, in the same way as described in the first embodiment, center point X of discharge gap 13 between tip surfaces 11a and 12a of both chips 11 and 12 is placed on center line m of spark plug 1, in this embodiment.

According to the structure shown in the second embodiment of FIG. 3, a whole length of side electrode 5′ becomes short so that spark plug 1 in this embodiment is advantageous in terms of a reduction in a thermal capacity. In addition, the tip outside portion 5c is of the cut out shape along the plane orthogonal to center line m of spark plug 1. Hence, especially, a miniaturization of a portion of spark plug 1 contacted with the initial flame and a further reduction of the quenching action can be achieved. It is noted that the angle of arm portion 5b′ with respect to straight line S may be wider than 90°. However, if this angle is wider than 90°, it becomes easily necessary to take a long whole length for side electrode 5′. On the contrary, if this angle is narrower than 90°, the initial flame is easily contacted with arm portion 5b′.

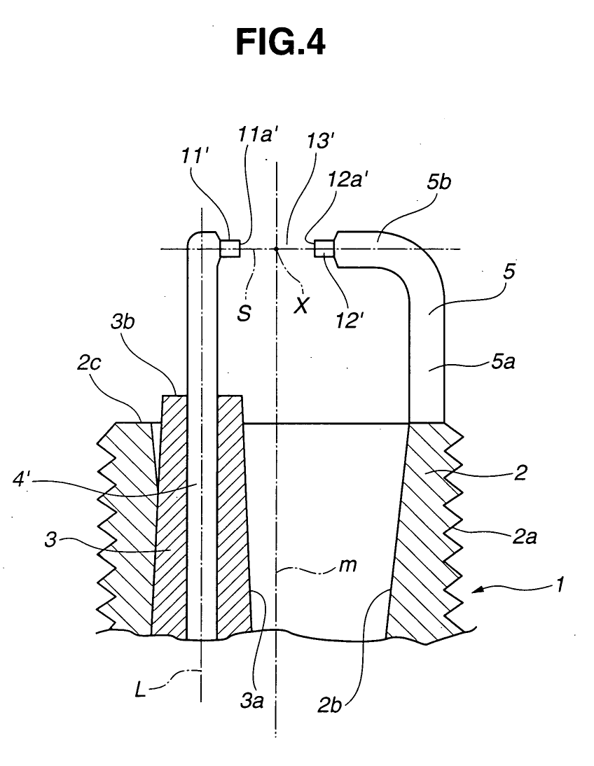

Next, FIG. 4 shows a third preferred embodiment of spark plug according to the present invention. In this embodiment, straight line S is intersected through 90° with center line m of spark plug 1. Center electrode side chip 11′ is attached onto a tip side surface of center electrode 4′ projected from insulator 3. Center electrode side chip 11′ is formed of the small-diameter cylindrical shape. Side electrode 5 is formed in an approximately letter-L shape in which an arm portion 5b is bent through 90° from base portion 5a. Side electrode side chip 12′ projected along an axial direction of arm portion 5b is attached onto the tip of arm portion 5b. Side electrode side chip 12′ is of the small-diameter cylindrical shape. Also in this embodiment, center point X of discharge gap 13′ between tip surfaces 11a′, 12a′ of both electrode side chips 11′, 12′ is placed on center line m of spark plug 1. It is noted that a height of center electrode 4′ from plug body tip portion 2c is approximately the same as the height of side electrode 5 from plug body tip portion 2c, as shown in FIG. 4.

The entire contents of a Japanese Patent Application No. 2004-156958 (filed in Japan on May 27, 2004) are herein incorporated by reference. The scope of the invention is defined with reference to the following claims.

1. A spark plug, comprising:
an approximately cylindrical plug body having a mounting screw portion;
a center electrode supported on an inside of the plug body via an insulator; and
a side electrode connected to a tip portion of the plug body and bent toward the inside of the plug body, an atmospheric discharge being carried out across a discharge gap between tip portions of the center and side electrodes, the center electrode being positioned eccentrically at an opposite side to the side electrode from a center line of the spark plug, and both of the tip portions of the center and side electrodes constituting the discharge gap being faced against each other with respect to the center line of the spark plug.

2. A spark plug as claimed in claim 1, wherein a center point of the discharge gap is positioned on the center line of the spark plug.

3. A spark plug as claimed in claim 1, wherein a straight line connecting both of the tip portions of the center and side electrodes is slanted through a predetermined angle with respect to the center line of the spark plug.

4. A spark plug as claimed in claim 1, wherein a tip portion of the insulator enclosing the center electrode is formed in an approximately cylindrical shape concentric to the center electrode.

5. A spark plug as claimed in claim 1, wherein mutually faced small-diameter chips are attached onto the tip portions of the center and side electrodes, respectively, and the discharge gap is formed between the mutually faced small-diameter chips.

6. A spark plug as claimed in claim 3, wherein a small-diameter center electrode side chip slanted through a predetermined angle with respect to a center line of the center electrode is attached onto the tip portion of the center electrode, a small-diameter center electrode side chip faced against the small-diameter center electrode side chip is attached onto the tip portion of the side electrode, and the discharge gap is formed between the center electrode side chip and the side electrode side chip.

7. A spark plug as claimed in claim 6, wherein a slanted approximately truncated cone shaped tapered portion whose diameter is gradually varied from an outer diameter of a general portion of the center electrode to an outer diameter of the center electrode side chip is attached onto the tip portion of the center electrode and the center electrode side chip is supported on the center electrode via the tapered portion.

8. A spark plug as claimed in claim 6, wherein the side electrode supports the side electrode side chip which is oriented in a direction slanted through the predetermined angle with respect to the center line of the spark plug, the side electrode comprises: a base portion extended in parallel to the center line of the spark plug; and an arm portion extended obliquely toward the inside of the plug body from the base portion and having the tip portion onto which the side electrode side chip (12) is attached, and an outside portion of the tip portion of the arm portion is formed in a shape cut out along a plane orthogonal to the center line of the spark plug.

9. A spark plug as claimed in claim 8, wherein the arm portion is extended along a direction approximately orthogonal to the direction toward which the side electrode side chip is oriented.

10. A spark plug as claimed in claim 6, wherein the predetermined angle is an acute angle.

11. A spark plug as claimed in claim 6, wherein the predetermined angle is an approximately 90°.

12. A spark plug as claimed in claim 6, wherein a height of the center electrode from a tip surface of the plug body is approximately the same as the height of the side electrode from the tip surface of the plug body and a straight line connecting both of the center and the electrode side chips is intersected through 90° with a center point of the discharge gap formed between tips of the center and side electrode side chips.

13. A spark plug comprising:
approximately cylindrical plug body means having a mounting screw portion;
center electrode means supported on an inside of the plug body means via insulator means; and
side electrode means connected to a tip portion of the plug body means and bent toward the inside of the plug body means, an atmospheric discharge being carried out across a discharge gap between tip portions of the center and side electrode means, the center electrode means being positioned eccentrically at an opposite side to the side electrode means from a center line of the spark plug, and both of the tip portions of the center and side electrode means constituting the discharge gap being opposed against each other with respect to the center line of the spark plug.
